(19) United States
(12) Patent Application Publication
(10) Pub. No.: US 2024/0078507 A1
(43) Pub. Date: Mar. 7, 2024

(54) MANAGEMENT DEVICE, MANAGEMENT METHOD, AND STORAGE MEDIUM

(71) Applicant: HONDA MOTOR CO., LTD., Tokyo (JP)

(72) Inventor: Koichiro Aikawa, Wako-shi (JP)

(21) Appl. No.: 18/239,135

(22) Filed: Aug. 29, 2023

(30) Foreign Application Priority Data
Sep. 2, 2022 (JP) 2022-140080

(51) Int. Cl. G06Q 10/087; G01G 17/00; G06Q 30/018; G06Q 50/04; G06V 20/60

(52) U.S. Cl. CPC G06Q 10/087; G01G 17/00; G06Q 30/018; G06Q 50/04; G06V 20/60; G06K 19/06037

(57) ABSTRACT

A management device according to an embodiment is a management device that manages environmental load information including information on environmental loads of a product or parts constituting the product and includes a weight acquirer configured to acquire a weight for each of the parts or raw materials constituting the parts, a material determiner configured to determine a material of the parts or raw materials on the basis of a captured image in which the parts or raw materials are captured, and a storage controller configured to associate information on the weight acquired by the weight acquirer with information on the material determined by the material determiner for each of the parts or raw materials, and to cause a storage to store a result of the association as the environmental load information.

### CROSS-REFERENCE TO RELATED APPLICATION

Priority is claimed on Japanese Patent Application No. 2022-140080, filed Sep. 2, 2022, the content of which is incorporated herein by reference.

### BACKGROUND

### Field of the Invention

The present invention relates to a management device, a management method, and a storage medium.

### Description of Related Art

Conventionally, efforts aimed at mitigating or reducing the impact of climate change are being continued, and research and development on reducing an amount of carbon dioxide emissions is being carried out to realize this goal. In relation to this, to conduct life cycle assessment (LCA) of products manufactured from respective processes by a plurality of companies, there is known a technology that enables an access to LCA-related information by collecting and aggregating information such as an amount of environmental pollutants generated and an energy consumption in each process via a network and attaching a barcode and the like to the products (for example, Japanese Patent No. 3361051).

### SUMMARY

Incidentally, to reduce an amount of carbon dioxide emissions, it is necessary to measure the amount of carbon dioxide emitted from products provided by companies. When LCA for industrial products is performed, it is desirable to conduct an evaluation that includes a time at which materials constituting the products are handled, but there have been problems that work of registering data on raw materials for each material is complicated, and that information required for LCA cannot be managed efficiently and accurately because a plurality of materials are handled during material manufacturing.

An object of this application is to manage the information required for LCA more efficiently and accurately to solve the problems described above. Then, by extension, it contributes to the mitigation or reduction in impact of climate change.

The management device, the management method, and the storage medium according to this invention have adopted the following configuration.

(1): A management device according to one aspect of the present invention is a management device that manages environmental load information including information on environmental loads of a product or parts constituting the product, and includes a weight acquirer configured to acquire a weight for each of the parts or raw materials constituting the parts, a material determiner configured to determine a material of the parts or the raw materials on the basis of a captured image in which the parts or raw materials are captured, and a storage controller configured to associate information on the weight acquired by the weight acquirer with information on the material determined by the material determiner for each of the parts or raw materials to cause a storage to store a result of the association as the environmental load information.

(2): In the aspect of (1) described above, the management device further includes a basic unit information acquirer configured to acquire basic unit information per unit amount of the parts or raw materials determined by the material determiner, in which the storage controller causes the storage to store the basic unit information or information including an environmental load amount for each of the parts or raw materials derived from the basic unit information and the information on the weight for each material manufactured using the material as the environmental load information.

(3): In the aspect of (1) described above, when a material is manufactured by melting the material, the storage controller causes the storage to store information including information on an amount of electric power consumed for the melting as the environmental load information.

(4): In the aspect of (1) described above, the management device further includes a calculator configured to calculate a hash value using a predetermined hash function for a part or all of the environmental load information and a generator configured to generate information on an access destination for viewing a part or all of the environmental load information.

(5): In the aspect of (1) described above, the material determiner determines at least one of a type of material of the parts or the raw materials included in the captured image, a supply source of the parts or the raw materials, and a state of the parts or the raw materials on the basis of mark information included in the captured image.

(6) A management method according to another aspect of the present invention includes, by a computer of a management device that manages environmental load information including information on an environmental load of a product or parts constituting the product, acquiring a weight for each of the parts or raw materials constituting the parts, determining a material of the parts or raw materials on the basis of a captured image in which the parts or raw materials are captured, and associating information on the acquired weight with information on the determined material for each of the parts or raw materials to cause a storage to store a result of the association as the environmental load information.

(7): A computer-readable non-transitory storage medium according to still another aspect of the present invention is a computer-readable non-transitory storage medium that has stored a program causing a computer of a management device that manages environmental load information including information on an environmental load of a product or parts constituting the product to execute acquiring a weight for each of the parts or raw materials constituting the parts, determining a material of the parts or raw materials on the basis of a captured image in which the parts or raw materials are captured, and associating information on the acquired weight with information on the determined material for each of the parts or raw materials to cause a storage to store a result of the association as the environmental load information.

According to the aspects of (1) to (7) described above, it is possible to manage information required for LCA more efficiently and accurately.

### BRIEF DESCRIPTION OF THE DRAWINGS

FIG. 1 is a diagram which shows an example of a configuration of an environmental load information management device according to an embodiment.

FIG. 2 is a diagram which shows an example of an LCA model when a factory product is manufactured.

FIG. 3 is a diagram for describing processing executed by an environmental load information management device in a process A.

FIG. 4 is a diagram for describing weight measurement of parts or raw materials and capturing of images.

FIG. 5 is a diagram for describing image analysis processing and material determination processing for a captured image.

FIG. 6 is a diagram for describing how the type of material is determined on the basis of the mark information included in the captured image.

FIG. 7 is a diagram which shows an example of contents of material inventory information.

FIG. 8 is a diagram which shows an example of contents of environmental load information.

FIG. 9 is a flowchart which shows an example of processing executed by an environmental load information management device.

### DESCRIPTION OF EMBODIMENTS

An embodiment of a management device, a management method, and a storage medium of the present invention will be described below with reference to the drawings.

In the following description, the management device of the embodiment is an environmental load information management device that manages environmental load information, which is information on an environmental load of at least a product or parts that constitute the product. The information on the environmental load includes, for example, an amount of greenhouse gas (GHG) emissions. GHG is, for example, carbon dioxide (CO₂). In addition, GHG includes at least one of methane (CH₄), nitrous oxide (N₂O), hydrofluorocarbons (HFCs), perfluorocarbons (PFCs), and sulfur hexafluoride (SF₆), instead of (or in addition to) carbon dioxide. The environmental load information is, for example, LCA data used for LCA (a method for quantitatively evaluating the environmental load in an entire or part of a life cycle of a certain product or service). In the following description, as an example, the environmental load information management device is provided at (or managed by) a material manufacturing company that manufactures materials for a product or parts.

[Device Configuration]

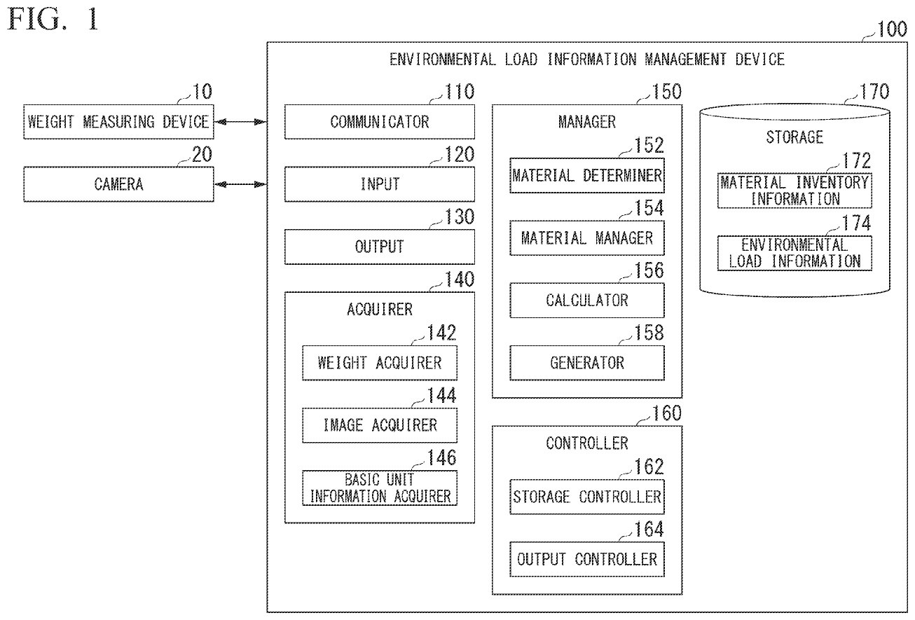

FIG. 1 is a diagram which shows an example of a configuration of an environmental load information management device 100 according to an embodiment. The environmental load information management device 100 shown in FIG. 1 includes, for example, a communicator 110, an input 120, an output 130, an acquirer 140, a manager 150, a controller 160, and a storage 170. The acquirer 140, the manager 150, and the controller 160 are each realized by a hardware processor such as a central processing unit (CPU) executing a program (software). Some or all of these components are realized by hardware (a circuit unit; including circuitry) such as large scale integration (LSI), an application specific integrated circuit (ASIC), an field-programmable gate array (FPGA), and a graphics processing unit (GPU) or by software and hardware in cooperation. The program may be stored in advance in a storage device (a non-transitory storage medium) such as a hard disk drive (HDD) or flash memory provided in the environmental load information management device 100, or may be stored in a detachable storage medium (a non-transitory storage medium) such as a DVD or CD-ROM and installed in the HDD or flash memory by the storage medium being attached to a drive device provided in the environmental load information management device 100. The environmental load information management device 100 is an example of a “management device.”

The storage 170 may be realized by various storage devices, a solid state drive (SSD), an electrically erasable programmable read only memory (EEPROM), a read only memory (ROM), a random access memory (RAM), or the like. The storage 170 stores, for example, material inventory information 172, environmental load information 174, a program, and other various types of information. The material inventory information 172 is information on material inventory managed in the environmental load information management device 100. A material is, for example, used by a material manufacturing company to manufacture a predetermined material (for example, parts that constitute a product manufactured at a delivery destination such as a molten metal, an ingot of a predetermined metal), and is specifically, for example, a recycled material such as recycled aluminum cans, recycled aluminum sashes, regenerated ingots such as iron ingots, or silicon component modifiers (additives). The environmental load information 174 includes, for example, information on an environmental load of a product or parts that constitute the product, and more specifically includes material information on parts or raw materials constituting the parts included in recycled material (hereinafter, simply referred to as “parts or raw materials”). The environmental load information 174 may include at least some of the information included in the material inventory information 172. The environmental load information 174 may include weight information by parts or raw materials. At least one of the material inventory information 172 and the environmental load information 174 may be stored, for example, in an external device (for example, a server device such as a cloud server) capable of communicating via the communicator 110. Details of the material inventory information 172 and the environmental load information 174 will be described below. Information stored in the storage 170 may be acquired by the acquirer 140 or may be generated by the manager 150 or the controller 160.

The communicator 110 communicates with an external device via a network. The network includes, for example, the Internet, a cellular network, a Wi-Fi network, a wide area networks (WAN), a local area network (LAN), a provider device, a wireless base station, and the like. The communicator 110 communicates with a weight measuring device 10, a camera 20, and other external devices.

The input 120 includes, for example, various keys, buttons, microphones, and the like. The input 120 receives, for example, an input by a key operation, a button operation, or the like from a user (including a worker, a manager, or the like) of the environmental load information management device 100. The input 120 may receive a user voice input via a microphone. The input 120 may be configured integrally with the output 130 as a touch panel.

The output 130 has, for example, a display and a speaker. The display is, for example, a liquid crystal display (LCD) or an organic electro luminescence (EL) display. The display displays various types of information under control of the output controller 164, which will be described below. A speaker outputs a predetermined voice under the control of the output controller 164.

The acquirer 140 acquires various types of information from the outside via the communicator 110 and the like. The acquirer 140 includes, for example, a weight acquirer 142, an image acquirer 144, and a basic unit information acquirer 146. The weight acquirer 142 acquires weight data for each of parts or raw materials measured by the weight measuring device 10 shown in FIG. 1. The weight measuring device 10 may be provided outside the environmental load information management device 100 or included in a configuration of the environmental load information management device 100. When it is provided outside, the weight acquirer 142 acquires a weight of the parts or raw materials measured by the weight measuring device 10 via a network NW.

The image acquirer 144 acquires images of the parts or raw materials captured by a camera (an example of an image-capturing unit) 20 shown in FIG. 1. The camera 20 is a digital camera using a solid-state image-capturing device such as a charge coupled device (CCD) or complementary metal oxide semiconductor (CMOS). The camera 20 may be provided outside the environmental load information management device 100 or may be included in the configuration of the environmental load information management device 100. When it is provided outside, the image acquirer 144 acquires image data (a captured image) captured by the camera 20 via the network NW. For example, one or more camera 20 are provided in a vicinity of the weight measuring device 10 and capture images including a measurement object while the weight measuring device 10 is measuring a weight of parts or raw materials (or before or after the measurement). The captured images may be images captured from the same direction, or images captured from different directions depending on a type and an amount (weight) of the parts or raw materials, a type of a conveyance member that conveys the parts or raw materials, and the like.

The basic unit information acquirer 146 acquires basic unit information per unit amount of the parts or raw materials from, for example, an external device (for example, a database server) capable of communicating via the communicator 110. Basic unit information includes, for example, the amount of GHG (for example, carbon dioxide) emissions per predetermined weight of the parts or raw materials. The basic unit information may be acquired from an external device in advance and stored in the storage 170, or may be acquired by accessing an external device when a material of the parts or raw materials is determined by the material determiner 152. Information acquired by the acquirer 140 may be stored in the storage 170 under control of the storage controller 162 described below.

The manager 150 manages a material inventory of the parts or raw materials, manages a manufacture of a new material using materials, manages environmental load information associated with the manufacture of a new material, and the like, manages information for delivering (delivery) the manufactured material to a delivery destination, and the like. The manager 150 includes, for example, a material determiner 152, a material manager 154, a calculator 156, and a generator 158.

The material determiner 152 performs, for example, image analysis on the captured image captured by the camera 20, and determines a material contained in the parts or raw materials on the basis of a result of the analysis. Determination of a material includes, for example, determination of a type of the material (a material type), and in addition, determination of a quality and quantity of the material may also be included. The material manager 154 manages the material determined by the material determiner 152, the captured image (image data), the weight of the material, and the like. The calculator 156 calculates a hash value using a predetermined hash function for a part or all of the environmental load information. The generator 158 generates information on an access destination for viewing some or all of the environmental load information. Details of each function of the material determiner 152, the material manager 154, the calculator 156, and the generator 158 will be described below.

The controller 160 includes, for example, a storage controller 162 and an output controller 164. The storage controller 162 associates weight information acquired by the weight acquirer 142 with material information determined by the material determiner 152 for each of the parts or raw materials and causes the storage 170 to store a result of the association as the environmental load information 174. The storage controller 162 may cause the storage 170 to store basic unit information for each of the parts or raw materials for each manufactured material, or information including an environmental load amount (for example, the amount of GHG emissions) for each of the parts or raw materials calculated based on the basic unit information and the weight information as the environmental load information 174. The storage controller 162 may cause the storage 170 to store information including information on an amount of electric power consumed for melting as the environmental load information 174 when materials are melted to produce a new part or material.

The output controller 164 outputs information acquired by executing each piece of processing in the environmental load information management device 100. The information described above includes the weight information measured by the weight measuring device 10, the captured images captured by the camera 20, the environmental load information, the information calculated by the calculator 156, the information generated by the generator 158, and other various types of information. The output controller 164 may generate an image containing various types of information to be output, display the generated image on a display of the output 130, generate a voice corresponding to the various types of information, and output the generated voice from a speaker. The output controller 164 outputs the various types of information to a cloud server and other external devices connected by the network via the communicator 110. Control by the storage controller 162 and the output controller 164 may be executed according to an instruction (control) from the manager 150.

[Management of Environmental Load Information]

Next, management processing of environmental load information executed in the environmental load information management device 100 of the embodiment will be described with reference to the drawings. Management processing of environmental load information includes generation of environmental load information, generation of various types of information associated with environmental load information (for example, a hash value and code information), storage and provision of generated information, and the like. Here, first, a LCA model regarding a manufacture of an industrial product will be described.

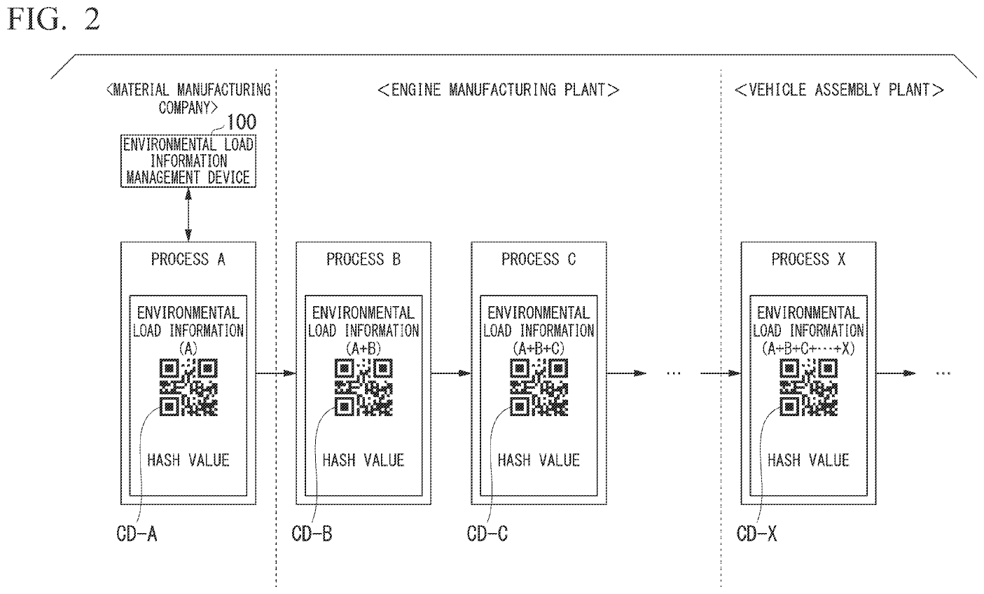

FIG. 2 is a diagram which shows an example of the LCA model regarding the manufacture of an industrial product. In the example of FIG. 2, it is assumed that a vehicle is used as an example of the industrial product. In the example of FIG. 2, a new material is manufactured using collected materials (resources such as recycled materials that are delivered) during an entire life cycle of a vehicle, and this material is used to manufacture a product (for example, an in-vehicle apparatus such as an engine or parts), and cycles such as distribution, consumption, recycling, and disposal of finished products, which indicate a cycle from assembly of a plurality of types of products to production of a vehicle, which is a finished product, may be included. A type of work process and the contents shown in FIG. 2 are not limited to these. A process may contain one or more work steps.

For example, in FIG. 2, a process A of using the collected materials to manufacture a material for manufacturing parts (an engine) that constitute a vehicle, a plurality of processes B, C, . . . , and so forth of using a material obtained by the process A to manufacture engines at an engine manufacturing plant, a plurality of processes X of assembling an engine and other parts manufactured at the engine manufacturing plant to complete a vehicle at a vehicle assembly plant, and so forth are shown. In the LCA model, new environmental load information including the environmental load information up to a previous process is generated in each process. Furthermore, code information (CD-A, CD-B, CD-C, . . . , CD-X, and so forth) including a hash value for proving a certainty of a part or all of the environmental load information and an access destination for causing a part or all of the environmental load information to be viewed from the outside is generated in each process. The code information includes, for example, a QR code (a registered trademark), a barcode, and the like. By generating a hash value and code information in each process, it is possible to prove a correctness of the environmental load information in each process. Although the environmental load information management device 100 according to the embodiment is used in a material manufacturing company that performs the process A, the environmental load information management device 100 may be provided for each process (or for each plant), and it may be configured so that it can be accessed from each of a material manufacturing company, an engine manufacturing plant, and a vehicle assembly plant as a cloud server.

Next, a relationship between the LCA model described above and the present embodiment will be specifically described, including a current background. In recent years, as carbon neutralization (reduction of the amount of GHG emissions to zero) has come to be required in response to a problem of global warming, evaluation of the amount of GHG emissions by LCA of industrial products has been required. Since industrial products such as vehicles are manufactured using a predetermined material (in the following description, description will be continued using an aluminum material as an example), it is required to ascertain the amount of GHG emissions in mining, manufacturing, transportation, and process of a material.

Many aluminum parts are manufactured from recycled aluminum, but recycled aluminum may include several different secondary materials (recycled materials: for example, aluminum cans, waste aluminum sashes) and primary aluminum materials (new materials) for component adjustment and additives such as silicon may have been input (mixed in) to a melting furnace, and the molten and mixed aluminum is cast and processed into parts such as an aluminum metal (ingot) and an engine block. Each material differs depending on a quality (performance) of the required aluminum metal and parts, and in calculation of the amount of GHG emissions, data on a type and an amount of input material are required to be accurately managed for each lot (a predetermined processing unit). The managed data (environmental load information) is required to be managed in a state where transparency (falsification prevention) is secured.

In the manufacture of aluminum materials (molten metal and ingots) using recycled aluminum materials, a material and the amount to be input to the melting furnace are determined by performing calculation based on past performance and the like, based on target material performance. Conventionally, this calculation has been performed manually by workers, and thus has taken time and has lead to mistakes. Conventionally, the type and amount (weight) of a material to be input, and the environmental loads (for example, the amount of GHG emissions) calculated based on these are manually input, and thus they are even more likely to have input errors in addition to an enormous burden applied. Furthermore, the environmental load information needs to be managed in a state that it cannot be falsified to ensure the LCA. For example, when disclosure of data is required in a downstream process of a supply chain (a side that uses aluminum materials), the data must be secured.

For this reason, the environmental load information management device 100 of the embodiment acquires a captured image of materials and a result of measuring a weight of the materials at a time of delivery of the materials (recycled materials) from a material supplier (for example, an aluminum can collector) in management of a material inventory (the types and amounts). The environmental load information management device 100 performs image analysis on the captured image and determines the types of the materials (a material type). The environmental load information management device 100 may also determine at least one of the type of material, a material supply source (a material supplier), and states (for example, quality and a ratio of a mixture) of parts or raw materials by including mark information ruled in advance in a photographing range and performing image analysis on the mark information. The environmental load information management device 100 manages the material inventory as environmental load information in association with image data, analyzed material types, weight, and the like. The environmental load information management device 100 manages managed data (environmental load information, and the like) while transparency (falsification prevention) is secured.

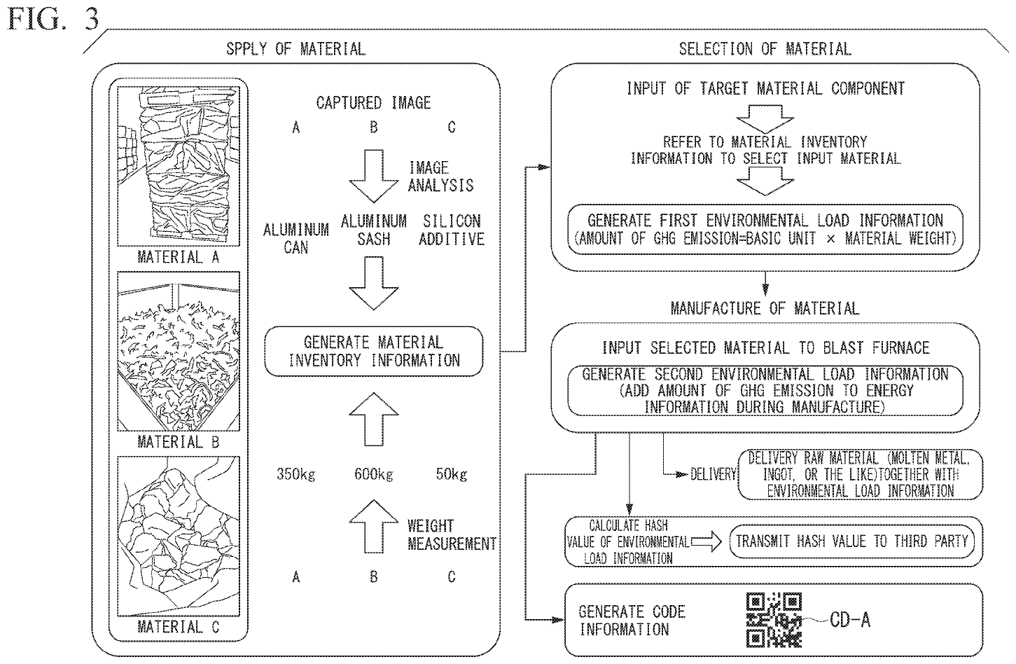

Next, processing of the process A using the environmental load information management device 100 of the embodiment will be specifically described. FIG. 3 is a diagram for describing the processing executed by the environmental load information management device 100 in the process A. In the process A, material supply, material selection, material manufacturing, material delivery, hash value calculation, code information generation, and the like are performed in more detail.

In the example of FIG. 3, when recycled materials such as one or more parts or raw materials are delivered from a supply source (a material supplier) to a material manufacturing company, the weight of the parts or raw materials is measured and an external image is captured. Three different recycled materials (parts or raw materials) shown in FIG. 3 are described below as materials A, B, and C.

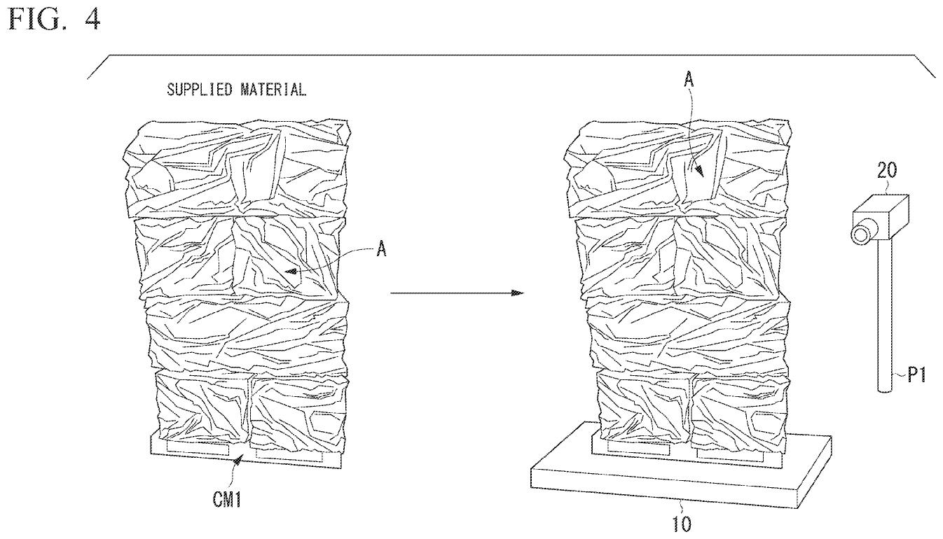

FIG. 4 is a diagram for describing the weight measurement of parts or raw materials and the image-capturing of images. As shown in FIG. 4, a material A is compressed or shaped into a predetermined shape and size by a supply source (a material supplier), and is supplied in a state of being accommodated (or placed) in a conveyance member CM such as a predetermined container, bag, table, or pallet. Then, weight of the material A is measured by the weight measuring device 10 by being placed on the weight measuring device 10 on the plate together with a conveyance member CM1. The weight acquirer 142 acquires the weight of the material A by subtracting a predetermined weight of the conveyance member CM1 from the weight measured by the weight measuring device 10.

The camera 20 is installed, for example, at a position P1 where an image of the material A in a state of being placed on the weight measuring device 10 can be captured. An installation position of the camera 20 may be more than one, and when the supply source (material supplier) is specified and the type of material can be predicted to some extent, it may also be movably installed such that a photographing position and an angle of view can be changed according to the predicted material type. The position and angle of view of the camera 20 may be adjusted according to an instruction from the controller 160. For example, the controller 160 may capture an image with the camera 20 at a timing when the weight of the material A is measured by the weight measuring device 10. As a result, an image of the material A can be efficiently captured without continuously photographing all the time. Since the weight measurement and image-capturing are performed at the same timing, it becomes easier to associate pieces of information with each other according to time information or the like. The pieces of information may be associated with each other according to other identification information or the like.

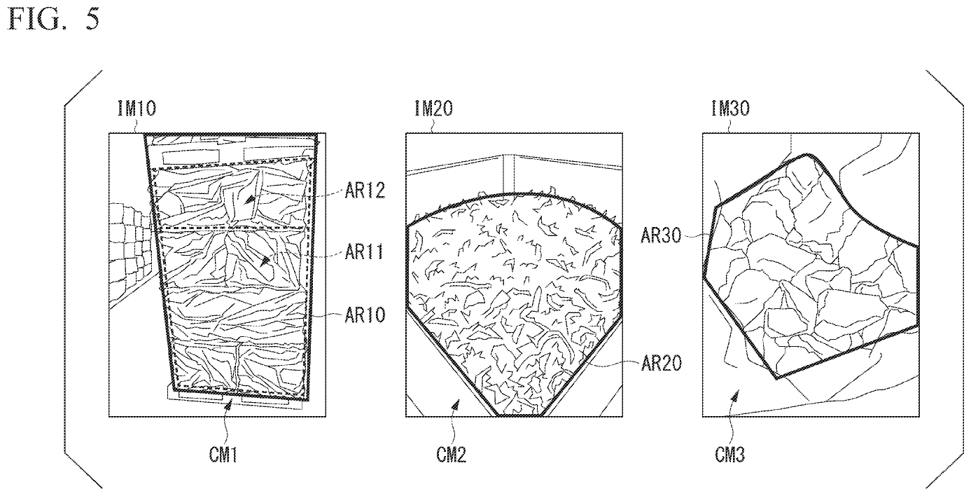

Returning to FIG. 3, the material determiner 152 performs image analysis on a captured image of an image-captured material and determines a material included in the captured image. FIG. 5 is a diagram for describing image analysis processing and material determination processing for the captured image. An example of FIG. 5 shows captured images IM10 to IM30 corresponding to three different materials A to C. For example, the material determiner 152 analyzes the captured images IM10 to IM30, extracts edge points having a large luminance difference from adjacent pixels in the image, and recognizes a contour area included in the image by linking the edge points. The material determiner 152 performs extraction of feature amounts such as a shape, a size, and color, extraction of image information by image enhancement processing or the like, and the like from the captured image, and refers to the extracted image information and a predefined model for pattern matching to determine the type of material included in the image by matching processing.

The material determiner 152 may extract an area (a material area AR10) that is predicted to be highly likely to contain a material on the basis of a result of the edge extraction, the feature amounts, and the like, and determine the type of material within the extracted area. For example, the material determiner 152 may also extract the material area AR10 on the basis of a position of the conveyance member CM included in an entire image area when the conveyance member CM obtained by the feature amounts of the image can be specified. For images IM20 and IM30, material areas AR20 and AR30 are similarly extracted from feature information of the image, and the material type is determined based on the feature information of the image in the extracted material areas AR20 and AR30. The material areas AR10 to AR30 described above may be set by a user using the input 120 based on the images IM10 to IM30 displayed on the output 130.

The material determiner 152 may determine a type of one material from one captured image, or may determine types of a plurality of materials and a proportion of respective materials from one image. For example, as shown in the image IM10, when the material area AR10 has different feature amounts such as color, the material area AR10 may be further divided into small areas AR11 and AR12, and types of materials contained in each area may be determined. Furthermore, the proportion of materials (for example, a material a1 is 70% and a material a2 is 30%) may be determined on the basis of a size (an image area, the number of pixels) of the small areas AR11 and AR12.

The material determiner 152 may determine the type of material according to a type of the conveyance member CM included in the captured image. For example, as shown in the images IM10 to IM30, since the conveyance members CM1 to CM3 are different in material quality, size, and color depending on a material, the type of conveyed material can be determined on the basis of the feature information of the conveyance member CM.

When a material to be determined by the material determiner 152 and the mark information are associated in advance, the type of material may be determined on the basis of the mark information included in the image. The mark information may include, for example, graphics, symbols, characters, patterns, character images of animals, anime characters, people, and the like, pictures of flowers, insects, famous landmarks (for example, Mt. Fuji), and the like. Information such as color may be associated with the mark information.

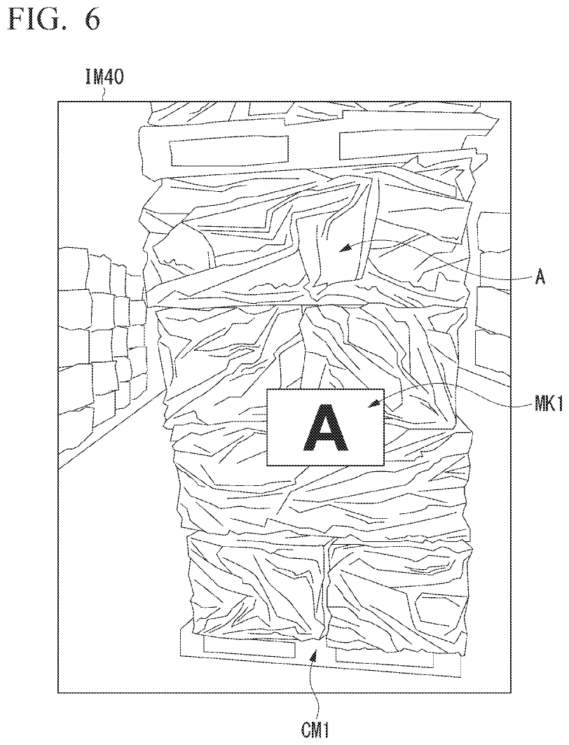

FIG. 6 is a diagram for describing how the type of material is determined on the basis of the mark information included in the captured image. An image IM40 shown in FIG. 6 includes plate-like mark information MK1 marked with “A” attached to an outer surface of the material A. The material determiner 152 recognizes mark information MK1 by performing image analysis, and determines the type of material included in the image on the basis of contents of the recognized mark information MK1. As a result, the type of material can be determined more accurately. Instead of (or in addition to) the type of material, at least one of identification information of a material supply source (a material supplier) or the states (for example, the quality and mixture ratio) of the parts or raw materials may be associated with the mark information MK1. As a result, information on the material A can be ascertained efficiently and accurately only by recognizing the contents of the mark information MK1. Information indicating the mark information MK1 and the contents meant by a mark may be stored in advance in the storage 170, or may be acquired from an accessible external device via the network.

The material determiner 152 may determine a material using a learned model in which the captured image serves as an input and the type of material included in the image serves as an output. This learned model may be updated using artificial intelligence (AI) functions such as machine learning (a neural network) using teacher (correct answer) data or the like, and deep learning. The learned model may be stored in the storage 170 or may be acquired from an external device via the network.

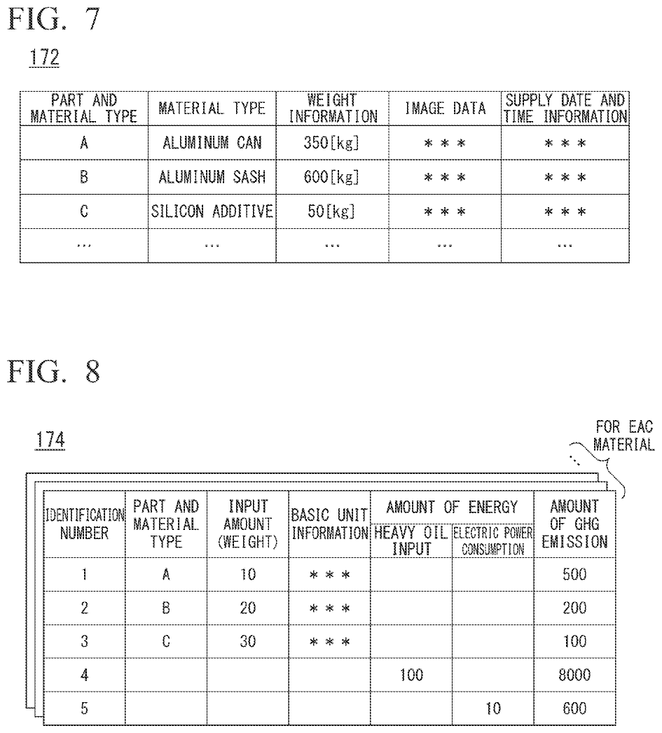

The material manager 154 associates the type of material of the parts or raw materials with the weight of the material and causes the storage 170 to store a result of the association as the material inventory information 172 FIG. 7 is a diagram which shows an example of the contents of the material inventory information 172. In the material inventory information 172, for example, a part or material type as identification information for identifying the parts or materials, a material type, weight information, image data, and supply date and time information are associated with each other. Material type stores the type of material that is determined by the material determiner 152 and included in the image (image data) captured by the camera 20. Weight information stores the weight of material included in the image data measured by the weight measuring device 10. When the material type contains a plurality of materials for the parts or raw materials, the weight of each material may be stored according to the ratio. Image data stores the image data of the material whose weight is measured. Supply date and time information stores a date and time when parts or raw materials are supplied to the material manufacturing company, or a date and time when the material type is determined by the material determiner 152. As a result, material inventory information managed by each material manufacturing company can be automatically generated, thereby reducing the burden on workers who have manually input data, and preventing input errors and the like. When materials are used for manufacturing a material, the material inventory information 172 is updated by the material manager 154 or the like in correspondence with the manufactured contents.

Under the control of the material manager 154 or the like, the storage controller 162 may cause an external storage connected via a network by the communicator 110 (for example, a database server or the like) to store the material inventory information 172 or may cause the material inventory information 172 to be stored therein.

Returning to FIG. 3, after generating the material inventory information 172 of supplied parts or raw materials, materials to be used for manufacturing a material are selected. For example, when the material manager 154 receives an input of a target material (for example, aluminum) and weight from the input 120, it refers to the material inventory information 172 and selects input materials to be input to a blast furnace when the material is manufactured. Specifically, the material manager 154 uses, regarding the selection and proportion of materials (for example, collected aluminum cans, recycled aluminum sashes, additives) to be used when an aluminum material is manufactured, material information managed in advance by the material manufacturing company and other institutions and automatically selects the materials and input amount (weight) based on performance of the target material. As a result, it is possible to reduce a work burden on a worker who selects materials, and to select materials more accurately.

At a stage of material selection, the calculator 156 multiplies, for example, basic unit information (for example, an amount of emissions of carbon dioxide per predetermined weight of material) according to the manufacture (for example, cutting, processing, melting) of a material, the type of the material (for example, aluminum, steel), and the like, and material weight (an input amount). With a value obtained by the multiplication as the amount of GHG emissions during material manufacturing, the generator 158 generates environmental load information (first environmental load information) in which the materials, the input amount, and the amount of GHG emissions are associated with each other.

Next, in material manufacturing work, the selected materials are put into the blast furnace. At this stage, the calculator 156 derives an amount of energy used for melting, transportation, and the like of the materials associated with material manufacturing, and derives the amount of GHG emissions based on the derived energy. Types of the amount of energy described above include, for example, an amount of heavy oil energy (an amount of heavy oil input) and an amount of electric power energy (an amount of electric power consumption). The amount of energy may include the amount of energy (an amount of conveyance energy) related to conveyance when a delivery is made from the material manufacturing company to a delivery destination (for example, an engine manufacturing plant). The calculator 156 calculates the amount of GHG emissions based on the amount of energy. For example, the calculator 156 calculates the amount of GHG emissions for the amount of energy by multiplying the amount of energy by a numerical value predetermined for each type of the amount of energy.

The generator 158 generates second environmental load information by adding the amount of GHG emissions to the amount of energy during material manufacturing to the first environmental load information. Then, the manufactured materials (for example, molten metal, ingots, or the like) are delivered to a delivery destination that manufactures the parts and products together with the environmental load information. The delivered environmental load information is the second environmental load information, but it may be the first environmental load information. The delivered environmental load information may include at least a portion of the material inventory information 172 (for example, information in which weight information and material information are associated with each of the parts or raw materials, for example).

FIG. 8 is a diagram which shows an example of contents of the environmental load information 174. In the environmental load information 174 shown in FIG. 8, part and material identification, input amount (weight), basic unit information, energy amount, and the amount of GHG emissions are associated with an identification number serving as identification information for identifying the amount of GHG emissions generated during material manufacturing. The first environmental load information described above includes information with identification numbers 1 to 3, and the second environmental load information includes information with identification numbers 1 to 5. In the example of FIG. 8, the environmental load information 174 includes both the basic unit and the amount of GHG emissions, but either one may be included. The environmental load information 174 is stored, for example, in association with (separately) for each material manufactured by a material manufacturing company. Therefore, environmental load information can be managed for each material.

The environmental load information 174 may be information in which weight information is associated with material information for each of the parts or raw materials using data of the material inventory information 172. In addition to the information described above, the environmental load information may be basic unit information for each of the parts or raw materials for each material manufactured using material, or information including an environmental load amount for each of the parts or raw materials derived based on the basic unit information and the weight information, and may also be information including information on an amount of electric power consumed for melting materials. For example, the generator 158 generates environmental load information including contents according to a type of material to be delivered to a delivery destination, the delivery destination, the contents according to an instruction from a worker, and the like.

When processing to prevent falsification of data included in the environmental load information is performed, the calculator 156 uses a predetermined hash function to calculate a hash value of the environmental load information corresponding to a material to be delivered. More specifically, the calculator 156 reads, for example, the environmental load information and applies a predetermined hash function to the environmental load information to calculate the hash value of the environmental load information. The predetermined hash function may be a predetermined fixed function, or may be a variable function that is set according to the type of material to be delivered, a delivery destination, and the like. The calculated hash value is transmitted to a disinterested third party (for example, a terminal device of a company that manages a distributed data base related to a block chain) to be managed. As a result, at the material delivery destination (an engine manufacturing industry side), it is possible to verify validity of the environmental load information (whether it has been falsified) by collating a hash value calculated using a predetermined hash function from environmental load information provided by a material manufacturing company and the hash value managed by the third party.

The material manufacturing company generates code information CD-A including information on an access destination for viewing a part or all of the environmental load information instead of (or in addition to) providing the environmental load information directly to the delivery destination using the generator 158. The information on an access destination is, for example, a URL address or the lie for referring to the environmental load information stored in a database server or the like that is communicable via the network. It is possible to disclose the environmental load information to the outside by delivering this code information together with a manufactured material, and it is possible to refer to the environmental load information by loading a material delivery destination in the code information CD-A. By delivering the calculated hash value and the generated code information together with the material, it is possible to indicate that the disclosed information has not been falsified, so that the validity of the information can be reliably proved.

[Processing Flow]

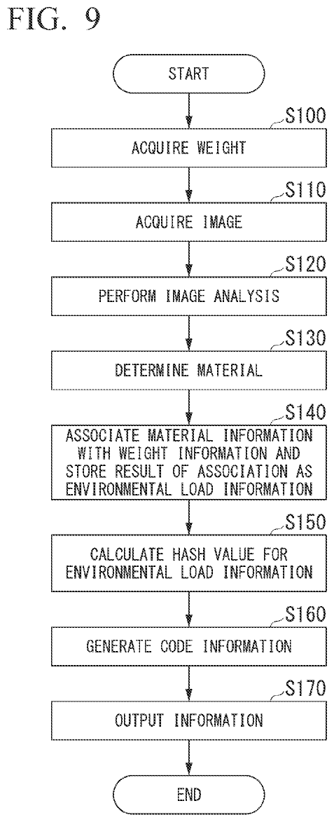

Next, processing executed by the environmental load information management device 100 of the embodiment will be described. FIG. 9 is a flowchart which shows an example of processing executed by the environmental load information management device 100. In the example of FIG. 9, the weight acquirer 142 acquires the weight of parts or raw materials measured by the weight measuring device 10 (step S100). Next, the image acquirer 144 acquires images of the parts or raw materials captured by the camera 20 and measured by the weight measuring device 10 (step S110). Steps S100 and S110 may be executed in reverse order or in parallel and weights and images for the same parts or raw materials are associated with each other. Next, the material determiner 152 analyzes the captured image (step S120). The material (for example, the type of material) included in the captured image is determined (step S130).

Next, the storage controller 162 associates material information and weight information for each of the parts and raw materials and stores a result of the association as environmental load information (step S140). Next, the calculator 156 calculates a hash value for the environmental load information (step S150). Next, the generator 158 generates code information (step S160). Next, the output controller 164 outputs the calculated hash value and the generated code information (step S170). As a result, processing of this flowchart ends. When a material is manufactured using materials, the environmental load information is updated on the basis of contents (the types and amounts) of the materials used in the manufactured material.

According to the embodiment described above, the information load information management device (an example of the management device) 100 that manages the environmental load information 174 including information on the environmental load of a product or parts that constitute the product includes the weight acquirer 142 that acquires the weight for each of the parts or raw materials that constitute the parts, the material determiner 152 that determines a material of the parts or raw materials on the basis of a captured image in which the parts or raw materials are captured, and the storage controller 162 that associates information on the weight acquired by the weight acquirer 142 with information on the material determined by the material determiner 152 for each of the parts or raw materials to cause the storage 170 to store a result of the association as the environmental load information 174, so that it is possible to manage information required for LCA more efficiently and accurately. Therefore, this can contribute to the mitigation or reduction in impact of climate change.

Specifically, according to the embodiment, the types of parts or raw materials are automatically determined based on image information and stored in association with the weight information, so that the information required for LCA can be recorded more efficiently and accurately. According to the embodiment, basic unit information required for LCA and/or GHG information calculated based on a basic unit are stored, so that necessary information can be accessed more directly. According to the embodiment, it is possible to disclose environmental load information to the outside, and to indicate that the disclosed information has not been falsified.

The embodiment described above can be expressed as follows.

The management device includes a storage medium that stores computer-readable instructions, and a processor that is connected to the storage medium, in which the processor executes the computer-readable instructions to manage environmental load information including information on an environmental load of a product or parts that constitute the product, acquire a weight for each of the parts or raw materials constituting the parts, determine a material of the parts or raw materials on the basis of a captured image in which the parts or raw materials are captured, and associate information on the acquired weight with information on the determined material for each of the parts or raw materials and cause a storage to store a result of the association as the environmental load information.

As described above, a mode for implementing the present invention has been described using the embodiments, but the present invention is not limited to such embodiments at all, and various modifications and replacements can be added within a range not departing from the gist of the present invention.

What is claimed is:

1. A management device that manages environmental load information including information on environmental loads of a product or parts constituting the product, comprising:
a weight acquirer configured to acquire a weight for each of the parts or raw materials constituting the parts;
a material determiner configured to determine a material of the parts or the raw materials on the basis of a captured image in which the parts or raw materials are captured; and
a storage controller configured to associate information on the weight acquired by the weight acquirer with information on the material determined by the material determiner for each of the parts or raw materials to cause a storage to store a result of the association as the environmental load information.

2. The management device according to claim 1, further comprising:
a basic unit information acquirer configured to acquire basic unit information per unit amount of the parts or raw materials determined by the material determiner,
wherein the storage controller causes the storage to store the basic unit information or information including an environmental load amount for each of the parts or raw materials derived from the basic unit information and the information on the weight for each material manufactured using the material as the environmental load information.

3. The management device according to claim 1,
wherein, when a material is manufactured by melting the material, the storage controller causes the storage to store information including information on an amount of electric power consumed for the melting as the environmental load information.

4. The management device according to claim 1, further comprising:
a calculator configured to calculate a hash value using a predetermined hash function for a part or all of the environmental load information; and
a generator configured to generate information on an access destination for viewing a part or all of the environmental load information.

5. The management device according to claim 1,
wherein the material determiner determines at least one of a type of material of the parts or the raw materials included in the captured image, a supply source of the parts or the raw materials, and a state of the parts or the raw materials on the basis of mark information included in the captured image.

6. A management method comprising:
by a computer of a management device that manages environmental load information including information on an environmental load of a product or parts constituting the product,
acquiring a weight for each of the parts or raw materials constituting the parts;
determining a material of the parts or raw materials on the basis of a captured image in which the parts or raw materials are captured; and
associating information on the acquired weight with information on the determined material for each of the parts or raw materials to cause a storage to store a result of the association as the environmental load information.

7. A computer-readable non-transitory storage medium that has stored a program causing a computer of a management device that manages environmental load information including information on an environmental load of a product or parts constituting the product to execute:
acquiring a weight for each of the parts or raw materials constituting the parts;
determining a material of the parts or raw materials on the basis of a captured image in which the parts or raw materials are captured; and
associating information on the acquired weight with information on the determined material for each of the parts or raw materials to cause a storage to store a result of the association as the environmental load information.
